(19) United States
(12) Patent Application Publication
(10) Pub. No.: US 2024/0032730 A1
(43) Pub. Date: Feb. 1, 2024

(54) Toaster Crumb Trap Door

(71) Applicant: Hector Torres, Trenton, NJ (US)

(72) Inventor: Hector Torres, Trenton, NJ (US)

(21) Appl. No.: 17/873,621

(22) Filed: Jul. 26, 2022

(51) Int. Cl. A47J 37/08; H05B 1/02; F24C 15/14

(52) U.S. Cl. CPC A47J 37/0871; H05B 1/0261; F24C 15/14

(57) ABSTRACT

The disclosure is the only product of its kind that has the capability of significantly reducing the time it takes to clean up leftover crumbs from regular toaster operation. The disclosure is uniquely designed with durable materials to ensure long term functionality and can be utilized to toast a wide variety of breads, pastries, and goods, etc. at the consumer's preference.

### BACKGROUND

A toaster is a staple home appliance for many individuals globally. The aftercare and cleaning process of toasters, however, can be incredibly time consuming and difficult. After normal usage often a growing pile of leftover crumbs can be found within the toaster and may present a fire hazard considering the accumulation of morsels could catch on fire. There have been no products available as original equipment or as an aftermarket to address this problem.

An apparatus to provide a simple and efficient way to clean out crumbs and debris from a toaster is not being met by any known device or system at present. There have been no products available as original equipment or as an aftermarket to address this problem either.

### SUMMARY OF THE INVENTION

The main purpose of the toaster crumb trap door is to provide a convenient tray compartment below a toaster to completely accumulate crumbs and simplify the crumb cleaning process, post use of the toaster.

### BRIEF DESCRIPTION OF THE DRAWINGS

FIG. 1 is a front perspective view of the toaster crumb trap door in accordance with an embodiment of the present disclosure.

FIG. 2 is a front perspective view of the toaster crumb trap door in accordance with an embodiment of the present disclosure.

FIG. 3 are sensors in communication between the toaster and the tray in accordance with embodiments of the present disclosure.

FIG. 4 is a side view of the latched door with hinge and pin in accordance with an embodiment of the present disclosure.

FIG. 5 is a side view of the latched door with hinge and pin in an open position in accordance with an embodiment of the present disclosure.

FIG. 6 is a top view of a swung open vertical trap door with a safety button in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

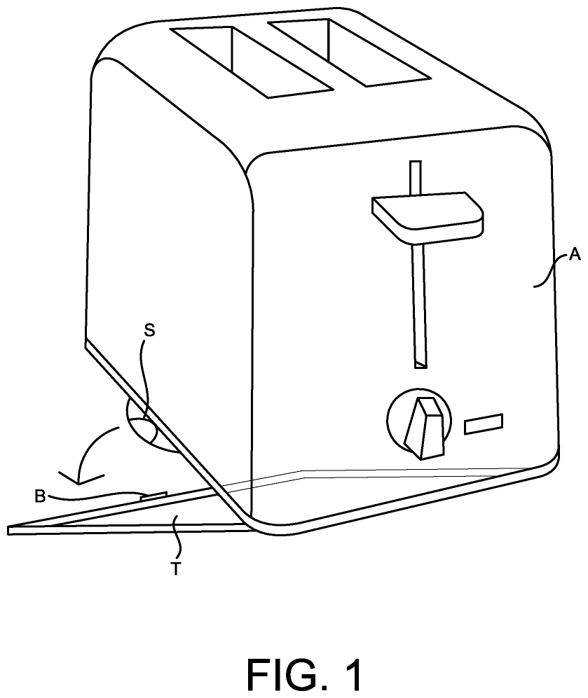

FIG. 1 is a front perspective view of the toaster crumb trap door showing: toaster referenced as A, latch referenced as B, and crumbs door T also known as a tray referenced as T, and sensor S in accordance with an embodiment of the present disclosure.

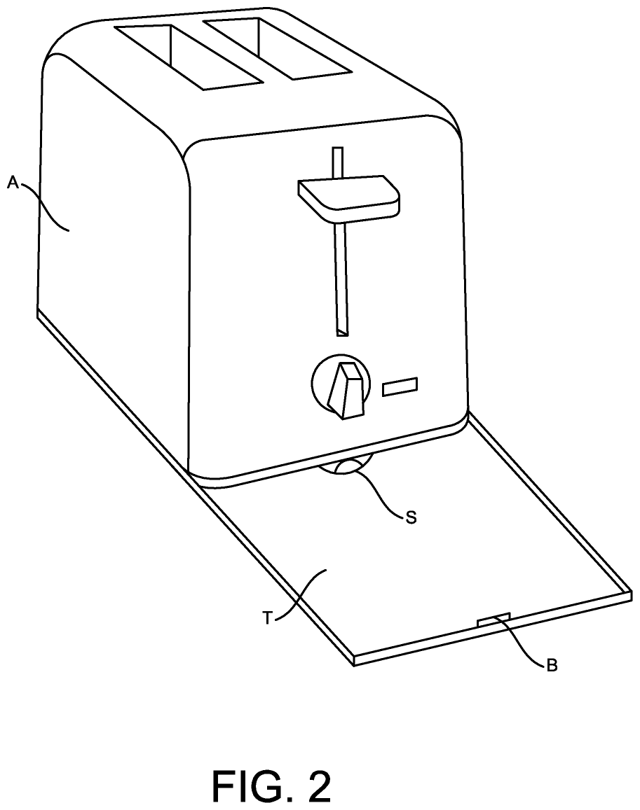

FIG. 2 is a front perspective view of the toaster crumb trap door showing: toaster referenced as A, latch referenced as B, and crumbs door T open in a sliding manner, and sensor S in accordance with an embodiment of the present disclosure.

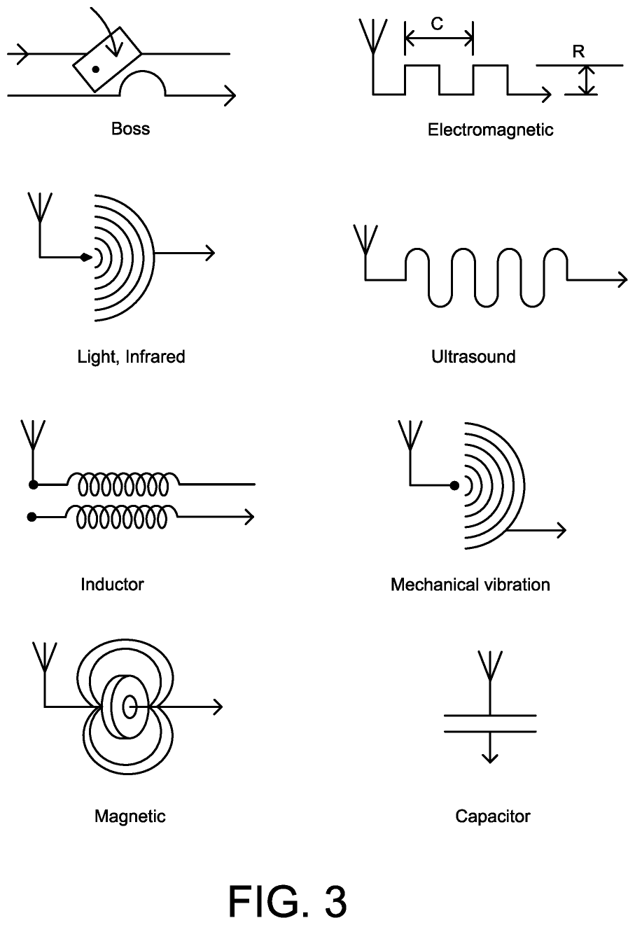

FIG. 3 are sensors in communication between the toaster and the tray in accordance with embodiments of the present disclosure. The embodiments of the sensors include respective generation and reception of a boss mechanical touch pressure switch, an electromagnetic pulse of cycle c and amplitude P, an infrared light generation and reflection respectively from the toaster appliance A to the tray T, an ultrasound reflection between the toaster appliance A to the tray T, an inductor proximity therebetween, a mechanical vibration therebetween, a magnetic field there between and a capacitive proximity there between. Generation of respective signals occur at the toaster appliance A and are received at the toaster appliance T or at the tray or reflected there between.

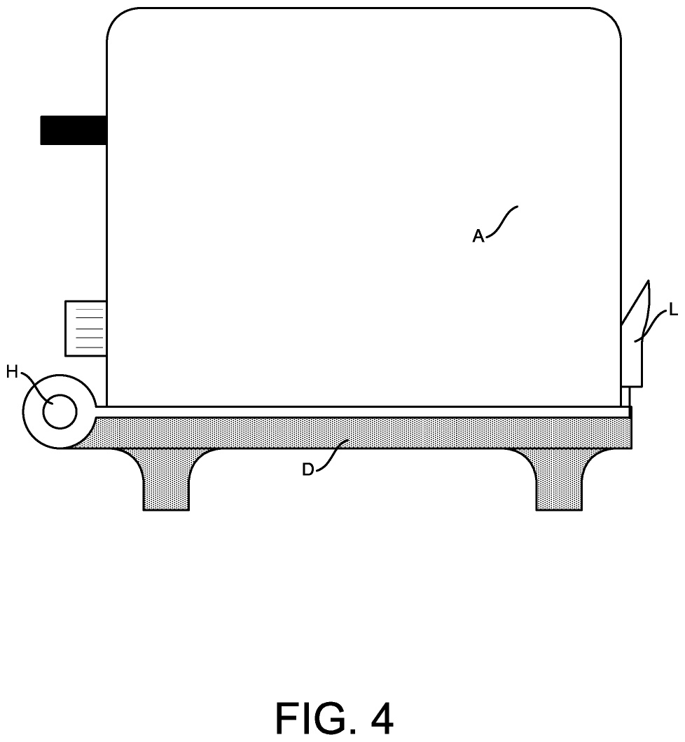

FIG. 4 is a side view of the latched door with hinge and pin in accordance with an embodiment of the present disclosure. The view includes the toaster A, the door D, the hinge H with pin and the latch L in a closed position. The door D also includes feet or stand offs from a counter top.

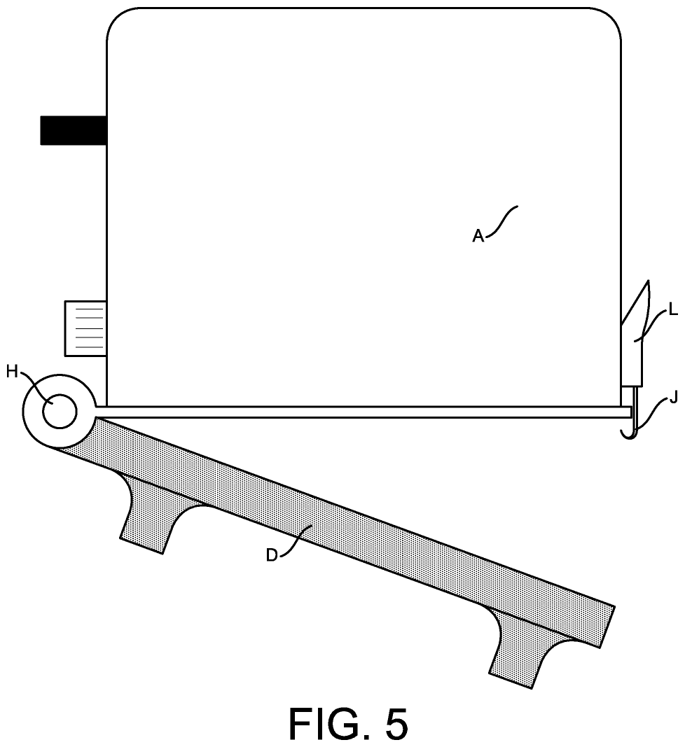

FIG. 5 is a side view of the latched door with hinge and pin in an open position in accordance with an embodiment of the present disclosure. The view includes the toaster A, the door D, the hinge H with pin and the latch L in a closed position. The door D also includes feet or stand offs from a counter top. A hook J secures the door D to the toaster A.

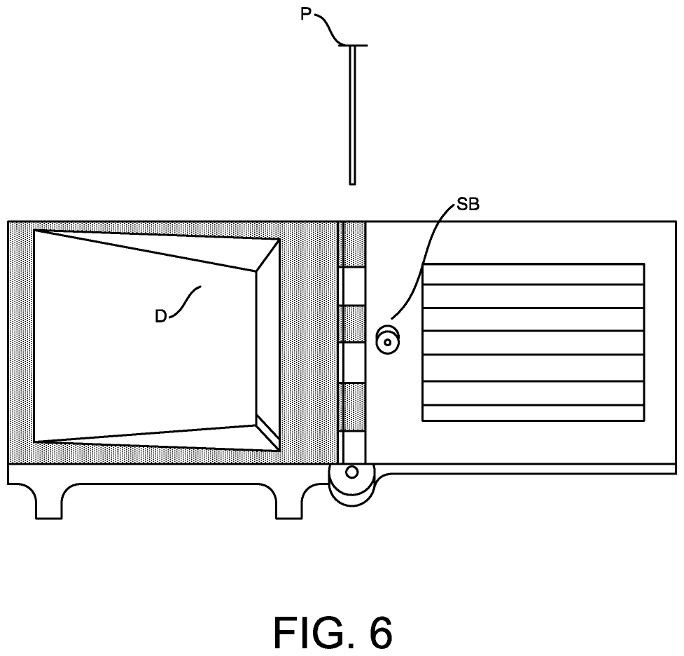

FIG. 6 is a top view of a swung open vertical trap door with a safety button in accordance with an embodiment of the present disclosure. The door D is swung in a one hundred and eighty degree position to the toaster A. A safety button SB shuts off the toaster A when in an open position. A pin P secures the hinge to the toaster A.

The present disclosed toaster crumb trap door, also known as the “Titantoaster” offers a novel detachable crumb tray with a safety trigger that halts toaster operation once the tray is open thus eradicating the possibility of an individual getting burned or hurt while cleaning the toaster. Expanding on the initial design of a modern toaster, this easy cleaning toaster disposes of all crumbs in one simple act. The tray is equipped with a latch to ensure the tray remains in position at all times while the retractable tray simply glides back into the toaster after the user dispenses of all residual crumbs. Additionally, the titantoaster ensures a fully operational toaster and therefore greatly simplifies the expulsion of crumbs, excess oil and dust from the interior of a toaster.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A kitchen appliance device comprising:
a tray moveably disposed on an underside of the appliance, the tray configured to catch crumbs and drippings from the food cooking in the appliance; and
a sensor configured to turn the appliance on and off based on a proximity of the tray relative to the appliance.

2. The device of claim 1, wherein the sensor comprises a magnet disposed on the appliance in the proximity to a magnet disposed on the tray.

3. The device of claim 1, wherein the sensor turns off the appliance based on a loss of physical contact of the tray to the appliance.

4. The device of claim 1, wherein the sensor turns on the appliance based on a physical contact of the tray to the appliance.

5. The device of claim 1, wherein the sensor is a mechanical boss pressure switch based on a movement of a boss on the appliance via the a position of the tray relative to the boss.

6. The device of claim 1, wherein the sensor detects a reflection of an ultrasound pulse from the appliance off the tray at a predetermined frequency and amplitude thereof indicative of the proximity.

7. The device of claim 1, wherein the sensor detects a reflection of an electromagnetic pulse from the appliance off the tray at a predetermined frequency and amplitude thereof indicative of the proximity.

8. The firearm camera of claim 1, wherein the sensor detects a mechanical vibration transfer from the tray to the appliance indicative of the proximity.

9. The device of claim 1, wherein the sensor detects a reflection of an infrared light generated from the appliance off the tray at a predetermined intensity indicative of the proximity.

10. The device of claim 1, wherein the sensor includes an inductance generated from the proximity of the tray relative to the appliance.

11. The device of claim 1, further comprising a capacitive proximity switch configured to turn off the appliance based on a non-proximity of the tray with the capacitive proximity switch.
